(19) United States
(12) Patent Application Publication
(10) Pub. No.: US 2026/0278444 A1
(43) Pub. Date: Sep. 17, 2026

(54) RESOURCE PREDICTION FOR QUANTUM ADVANTAGE ON THE USAGE OF GATED QUANTUM COMPUTERS

(71) Applicant: Dell Products L.P., Round Rock, TX (US)

(72) Inventors: Miguel Paredes Quiñones, Campinas (BR); Diego Vrague Noble, Pelotas (BR); Ítalo Gomes Santana, Rio de Janeiro (BR)

(21) Appl. No.: 19/036,840

(22) Filed: Jan. 24, 2025

(51) Int. Cl. G06N 10/60; G06N 10/20; G06N 20/20

(52) U.S. Cl. CPC G06N 10/60; G06N 10/20; G06N 20/20

(57) ABSTRACT

One example method includes selecting a set of classical computing algorithms, solving, using the classical computing algorithms, respective problem instances of a problem to obtain a set of executions, where respective ML (machine learning) models were trained using the executions of the problem instances to predict a respective amount of classical computing resources needed to execute a respective one of the problem instances by each of the classical computing algorithms, in a loop, using an ensemble ML model to predict the classical resources needed to solve the problem, and when the predicted classical resources exceed defined classical resource limits, ending the loop, constructing a quantum circuit that comprises, as among a respective set of gates and qubits of quantum algorithms in a group of quantum algorithms, a smallest set of gates and qubits, and determining minimum requirements of quantum hardware needed to run the quantum circuit with a specified fidelity.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

One or more embodiments disclosed herein generally relate to quantum computing. More particularly, at least some embodiments relate to systems, hardware, software, computer-readable media, and methods, for resource prediction for quantum advantage on the usage of gated quantum computers.

### BACKGROUND

Quantum advantage marks the point at which a quantum computer can perform a specific task that is infeasible for any classical computer in terms of speed, cost, or energy consumption, where this task has a practical relevance. On the other hand, quantum utility is the point at which classical computers and quantum computers can start to compete with one another at solving a meaningful problem. In practice however, determining whether a quantum or classical approach should be employed in solving a particular problem can be difficult, and May present a variety of challenges. One such challenges is calculating the resources needed for quantum and classical computing in solving a problem using a specific algorithm. Another challenge is determining limits on classical resources for a problem to be solved with classical computers. Finally, it can be challenging to predict when a determined problem will attain quantum advantage.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings. It is noted that color versions of FIGS. 1, 4 and 6, are attached hereto, and incorporated herein, as an Appendix to the present disclosure.

FIG. 1 discloses a plot of circuit depth and width, that is, the number of qubits, required for solving different problem instances-colors in FIG. 1 (see Appendix) indicate the fidelity achieved in long hardware.

FIG. 2 discloses aspects of a schema, according to one embodiment.

FIG. 3 discloses details for finding the ML model parameters (θ) and the maximum error (ϵ) to attain fidelity f*, according to one embodiment.

FIG. 4 discloses aspects of a quantum circuit with a set of operations (gates) manipulating qubits and quantum states.

FIG. 5 discloses aspects of a geometrical interpretation of a quantum system with one qubit forming a vectorial basis with two components (|0 [symbol] and |1 [symbol] )—the quantum state |s [symbol] is a linear combination, or superposition, between the components of the basis.

FIG. 6 discloses an example in which evolution of the probability distribution of an example quantum algorithm from a dataset as the number of shots increases until 400 shots, according to one embodiment.

FIG. 7 discloses an example computing entity configured and operable to perform any of the disclosed methods, processes, and operations.

### DETAILED DESCRIPTION OF SOME EXAMPLE EMBODIMENTS

One or more embodiments disclosed herein generally relate to quantum computing. More particularly, at least some embodiments relate to systems, hardware, software, computer-readable media, and methods, for resource prediction for quantum advantage on the usage of gated quantum computers.

One or more embodiments comprise a schema, which may include a method and/or architecture, that may determine the existence of a quantum advantage with respect to a particular problem, and the type and amount of quantum resources that will be needed, to solve that particular problem. A method of such a schema may be implemented using a classical computing infrastructure, while resolution of the particular problem may be implemented using a quantum computing infrastructure which may comprise components such as, but not limited to, one or more quantum annealers.

A method according to one embodiment may comprise various operations, including: selecting a problem type P that is likely to be easily solved by a quantum computer but difficult to solve with a classical computer; select a set of classical algorithms A₁ . . . Aₙ that are state-of-the-art classical algorithms to solve P; using existing, or generate, different small-size instances of P and solve each of the instances with A₁ . . . Aₙ; for each algorithm, building a dataset composed of the executions of these instances and training an individual ML model to predict classical resources to execute a given input instance in the corresponding algorithm; creating an ensemble model M_{P} of all trained ML models; in a loop, generating a large instance pᵢ∈P and use M_{P} to predict the classical resources needed to solve p; and check if those classical resources surpass defined classical limits and, when an instance problem p_{i* is not solvable using classical resources by M}_{P}, stopping the loop; constructing a quantum circuit C that uses the smaller number of gates and qubits among the different quantum algorithms available that solve this type of problem; using a QRE to determine the minimum requirements of quantum hardware to run C with high fidelity; and, identifying quantum hardware that meets the minimum requirements of quantum hardware h_{q} to run C with high fidelity. The circuit C may then be run on the identified quantum hardware. It is noted that a specified fidelity may depend on the problem that is being solved, and there exist problems that accept low fidelities to obtain a solution, while other problems require a higher, or maximum, fidelity.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a type and amount of quantum resources needed to execute a given circuit may be determined. An embodiment may determine limits of a classical computing infrastructure with respect to solution of a particular problem. Various other advantages of one or more example embodiments will be apparent from this disclosure.

### A. REFERENCES

Reference is made herein to the following documents, each of which is incorporated herein in its respective entirety by this reference.
[1] “Quantum Computing Use Cases—What You Need to Know/Mckinsey.” Accessed Aug. 2, 2024. https://www.mckinsey.com/capabilities/mckinsey-digital/our-insights/quantum-computing-use-cases-are-getting-real-what-you-need-to-know.
[2] Lubinski, Thomas, Sonika Johri, Paul Varosy, Jeremiah Coleman, Luning Zhao, Jason Necaise, Charles H. Baldwin, Karl Mayer, and Timothy Proctor. “Application-Oriented Performance Benchmarks for Quantum Computing.” arXiv, Jan. 9, 2023. http://arxiv.org/abs/2110.03137.
[3] U.S. patent application Ser. No. 18/926,102, filed 24 Oct. 2024, and entitled EFFICIENT APPROXIMATION OF A CIRCUIT KNITTING SCHEME.
[4] DeCross, Matthew, Reza Haghshenas, Minzhao Liu, Enrico Rinaldi, Johnnie Gray, Yuri Alexeev, Charles H. Baldwin, et al. “The Computational Power of Random Quantum Circuits in Arbitrary Geometries.” arXiv, Jun. 21, 2024. http://arxiv.org/abs/2406.02501.
[5] The GQI Quantum Resource Estimator Playbook—Quantum Computing Report

### B. ASPECTS OF AN EXAMPLE CONTEXT AND OPERATING ENVIRONMENT FOR ONE EMBODIMENT

The following is a discussion of aspects of an example context and operating environment for various embodiments. This discussion is not intended to limit the scope of the claims or this disclosure, or the applicability of the embodiments, in any way.

Quantum advantage marks the point at which a quantum computer can perform a specific task that is infeasible for any classical computer in terms of speed, cost, or energy consumption, where this task must have a practical relevance. On the other hand, quantum utility is the point at which classical computers and quantum computers can start to compete with one another at solving a meaningful problem. In other words, it is a point at which quantum computers can be useful when quantum computation provides reliable, accurate solutions to problems that are beyond the reach of brute force or approximation classical computing methods. This means that the better the classical heuristic for a problem, the harder it will be for a quantum computer to provide quantum utility for this problem.

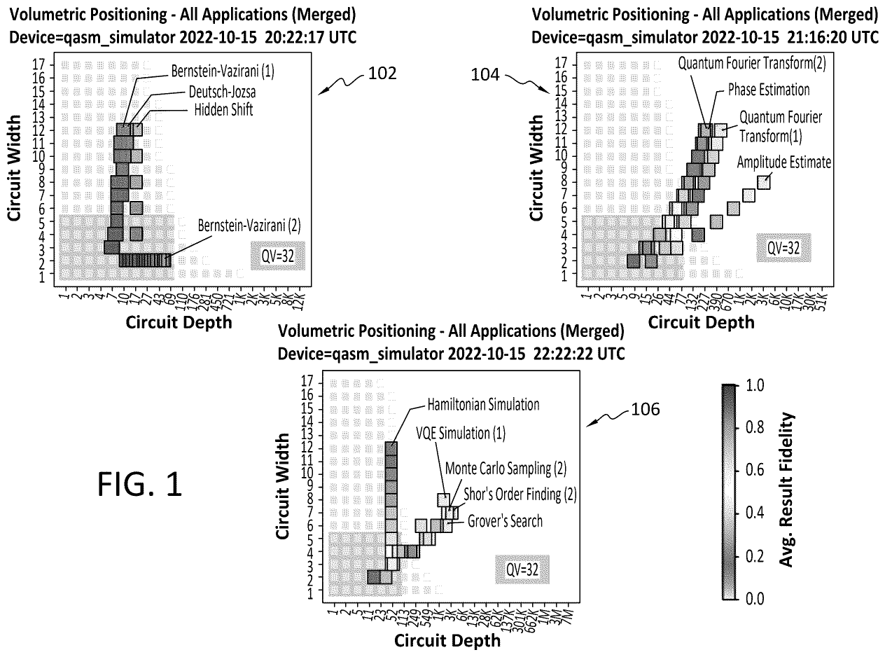

It is important to have an orientation in identifying problems that may present quantum advantage so they can be further investigated rather than an unsystematic exploration of computational problems for the same purpose. With reference now to FIG. 1, various plots 102, 104, and 106 (see [1]), are disclosed. These plots 102, 104, and 106, display circuit depth and width, that is, the number of qubits, required for solving different respective problem instances. Colors (see Appendix) indicate the fidelity achieved in IonQ (https://ionq.com/) hardware.

For example, the requirements of the Hamiltonian simulation problem, as shown in the plot 106, stop to grow in depth in comparison with the other problems, making this problem a good candidate to be tested first. Others suggest more applicable optimization problems as the first ones in attaining quantum advantage [1]. Although the hardware requirements stated in their work for reaching advantage to solve these problems are present in current quantum hardware, no such advantage have yet been found in preliminary experiments.

A Quantum Resource Estimator (QRE) is a tool able to recognize the requirements of quantum hardware for running a determined quantum algorithm. In other words, the QRE may serve as a proxy to find quantum advantage. This tool offers value beyond just providing raw metrics of resource requirements. For example, for quantum software engineers comparing different algorithm variants, and for software engineers developing a new optimization compiler, tools such as a QRE may help in identifying the most effective algorithm. Additionally, for hardware engineers, such tools may assist in setting targets for the number of qubits and the quality requirements for future architecture designs.

### C. DETAILED DISCUSSION OF ASPECTS OF ONE OR MORE EMBODIMENTS

One example embodiment considers that a problem is selected to obtain the inflection point where classical computing is not enough to solve a specific instance of the problem, and then determining the minimum requirements, that is, the minimum quantum computing resources such as quantum computers, to solve this instance.

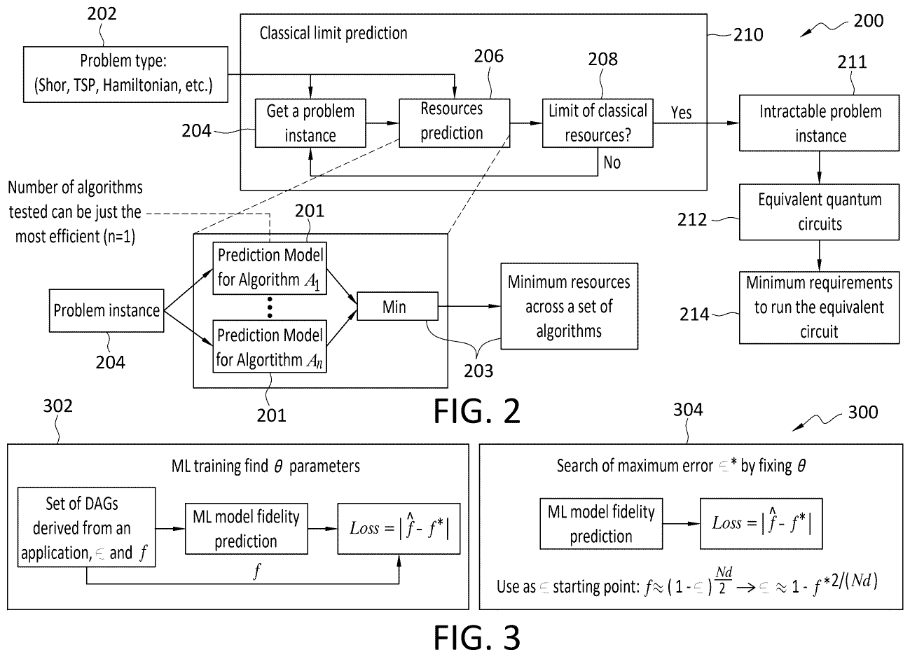

With reference now to the example schemas 200 and 300 respectively disclosed in FIGS. 2 and 3, details are provided concerning some aspects of an example embodiment. With reference first to the example of FIG. 2, an example method according to one embodiment may comprise the following operations:
1. select 202 a problem type P that is likely to be easily solved by a quantum computer but difficult by a classical computer, and then selecting 204 a particular problem instance of the problem type P—in an embodiment, this selection may not need to be made if only one problem type is being tested, that is, a specific problem instance may be selected 204;
2. after a particular problem instance has been selected 202, the method advances to a resource prediction process 206—as shown, the resource prediction process 206 may comprise the selection of a set of classical algorithms A₁ . . . Aₙ 201, which may comprise state-of-the-art classical algorithms, to solve the selected problem instance—it is noted that these classical algorithms A₁ . . . Aₙ 201 may be restricted to just one if there exist computational complexity demonstrations that that particular one is the most efficient among the others for most cases of practical interest;
3. next, small-size instances of the problem type P, which may be existing instances or newly generated instances, may be solved using the set of classical algorithms A₁ . . . Aₙ 201—for each algorithm in the set of classical algorithms A₁ . . . Aₙ 201, building a dataset comprising the executions of the selected 204 instance of the problem type P and training a respective ML (machine learning) model to predict 206 the minimum classical resources 203 needed to execute the selected 204 instance of the problem type P in the corresponding algorithm—that is, the output of the prediction 206 may comprise the minimum amount of classical resources 203, as amongst all the respective classical resources predicted by the classical algorithms A₁ . . . Aₙ 201, needed to execute the selected 204 instance of the problem type P—it is noted that in an embodiment, an ensemble model M_{P} may be created that includes all the trained ML models;
4. next, the limits of the classical resources may be defined using a loop process—that is, in a loop, generate a large instance pᵢ∈P and use the ensemble model M_{P} to predict the classical computing resources needed to solve pᵢ and then check 208 if those predicted classical computing resources exceed the defined classical limits—if not, the loop may repeat, but when the instance pᵢ* of the problem is not solvable by M_{P} using classical resources within the defined classical limits, the loop stops, ending the classical limit prediction phase 210 of the method;
5. the instance pᵢ* of the problem may thus be identified 211 as intractable, so far as the classical computing resources are concerned;
6. the method may then advance to the creation 212 of equivalent quantum circuits—that is, a quantum circuit C may be constructed that uses the smallest respective number of gates and qubits identified by the different quantum algorithms that are available for solving this type of problem;
7. then, a determination 214 is made as to the minimum requirements of quantum hardware needed to run C with a defined acceptable level of fidelity—in an embodiment, this determination 214 may comprise the following operations, shown in the example schema 300 in FIG. 3, which discloses details for finding, respectively, 302 the ML model parameters (θ), and 304 the maximum error (ϵ) permissible while still attaining a desired fidelity f*;
   a. training a ML model that predicts the fidelity of a given quantum circuit executed on a determined quantum hardware—in an embodiment, this may be accomplished by using a ML M_{Q} as disclosed in [3], where M_{Q} is a differentiable model; and
   b. using ML \hat{f}=M_{Q}(θ,C,h_{q}) to find the appropriate hardware parameter values ha that match a desired fidelity f*—for this, an embodiment may fix ML parameters θ determined above in a., and circuit parameters C and an approximation numeric technique to find h_{q} (for example, using the Newton-Raphson method since M_{Q} is differentiable)—in an embodiment, a starting point for the numeric technique to find the h_{q} parameters can be informed—one example of a quantum hardware parameter used in an embodiment is the two-qubit gate error ϵ, where, for this parameter, guesses for the initial value that is correlated with the desired fidelity may be obtained using [4], or other approximation method that does not imply in run ideal simulations for comparison.

$$ϵ \approx 1 - {f}^{* 2 / ( N \cdot d )} ,$$

where N is the number of qubits and d is the depth of the circuit—it is noted that, in one embodiment, if some parameters are considered already optimal, or very difficult to be improved in a short time, those parameters may be fixed as the best values as among the current state-of-the-art hardware;
8. finally, find a quantum hardware that matches with the required quantum hardware parameters hg determined as in 7. above—in the event such hardware is not yet developed, a user may look to hardware provider roadmaps to verify when all quantum hardware is expected to be available that will meet the required quantum hardware parameters h_{q}.

With respect to the example schemas 200 and 300 of FIGS. 2 and 3, if there is a need to detect only quantum utility, operations 2. through 4. of the example method discussed above may be omitted. That is, those operations 2. through 4. may be omitted since some problems to test quantum utility do not have a reliable classical algorithm to solve a small instance of a problem. In connection with the schemas 200 and 300, it is noted that “small size instances” of a problem type refer to problems of a size that can be solved relatively quickly, such as in a matter of seconds, and can be solved using the memory of PCs. Such small size instances may be used in an embodiment so that many of them can be run to generate data.

### D. FURTHER DISCUSSION

As disclosed herein, one or more embodiments may possess various useful features and aspects, although no embodiment is required to possess any of such features or aspects. The following examples are illustrative, but not exhaustive.

An embodiment may comprise a method that finds limits of classical computing resources to solve a problem type, by identifying a problem instance where given classical resources are expected to be exceeded in order to be able to solve the determined problem instance. An embodiment may create and use a QRE that is based on classical ML and that is configured and operable to determine quantum computing resources needed to solve a problem. An embodiment may comprise a pipeline to detect quantum computing requirements to obtain quantum advantage on a given problem.

### E. SUPPLEMENTAL INFORMATION AND CONSIDERATIONS

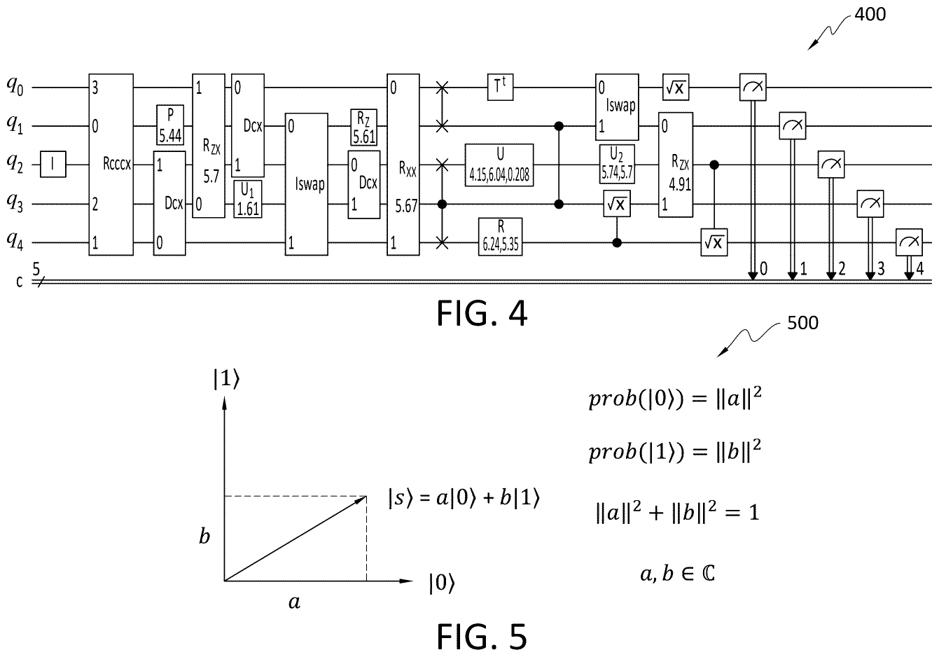

Gate-based quantum computing is the most generic form of quantum computation. A quantum circuit is the equivalent of a quantum algorithm. That is, the quantum circuit contains the set of instructions that manipulate quantum states. FIG. 4 discloses an example quantum circuit 400 with a set of operations, or gates, manipulating qubits and quantum states.

Quantum bits, or qubits, in a quantum circuit, in turn, form a vectorial basis with 2n components, where n is the number of qubits, and linear combinations of the components of the basis form the referred quantum states. A measurement is a projection of the final quantum state, at the end of the algorithm, onto one component of the basis. It may also be stated that a state collapses onto one of the components. Following the rules of quantum physics, the collapse is probabilistic, and the probability of a state collapsing onto one of the components is equal to the square of the magnitude of the (complex) amplitude of the state along that component, as illustrated in FIG. 4 for a single qubit.

With attention now to FIG. 5, a geometrical interpretation 500 is disclosed of a quantum system with one qubit forming a vectorial basis with two components (|0 [symbol] and |1 [symbol] ). The quantum state |s [symbol] is a linear combination (or superposition) between the components of the basis.

In practice, and following the rules of quantum physics, the state vector |s [symbol] may never be obtained directly. Each run of the quantum algorithm, a shot, collapses onto one of the basis states via a measurement operation. After several shots, an estimate of the probability distribution may be obtained that corresponds to the components of |s [symbol] . Namely, this probability distribution evolves towards a stable configuration, from which can be derived the components of |s [symbol] , as illustrated in FIG. 5. The probability distribution of the output states is typically obtained by counting the number of times |s [symbol] collapses onto each component of the basis and then normalizing the counts to sum to 1.

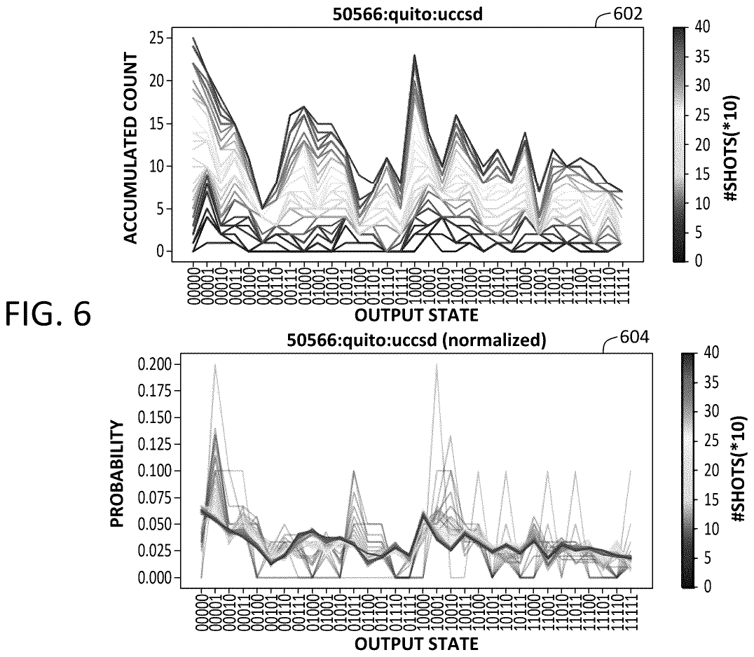

FIG. 6 shows an evolution of the probability distribution of an example quantum algorithm from a dataset as the number of shots increases until 400 shots. The algorithm works on a quantum system with five qubits, meaning that the vectorial basis has 2⁵=32 components. The top plot 602 shows the accumulated count of the number of times each basis component was measured at the output, and the bottom plot 604 shows the normalized counts forming a probability distribution. Note how the distribution evolves to a stable configuration as the shots are executed.

One of the main limiting factors in quantum computing is the presence of noise across the system. In addition to the probabilistic nature of quantum computations, noise augments the non-determinism of quantum circuit results. Executing several shots of the algorithm, however, is costly, and the right number of executions to obtain signal from noise is unknown a priori. The noisier the system, the more shots are required. Therefore, improving noise mitigation approaches can be important to achieving mainstream adoption and usage of quantum computers.

One way to avoid noise completely is to use quantum simulation engines. Those engines typically run on classical HPC environments, or hyper-scalers. Noise-free simulators essentially apply to internal quantum state vector representations the linear algebra corresponding to the quantum circuits' gates. Because quantum states grow exponentially with the number of qubits, several optimizations are implemented to reduce memory consumption and improve computation efficiency overall.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence now other than the specific sequence recited.

### G. FURTHER EXAMPLE EMBODIMENTS

Following are some further example embodiments. These are presented only by way of example and are not intended to limit the scope of this disclosure or the claims in any way.
Embodiment 1. A method, comprising: selecting a problem of a type; selecting a set of classical computing algorithms; solving, using the classical computing algorithms, respective problem instances of the problem to obtain a set of executions of the problem instances; wherein respective ML (machine learning) models were trained using the executions of the problem instances to predict a respective amount of classical computing resources needed to execute a respective one of the problem instances by each of the classical computing algorithms; in a loop, using an ensemble ML model that comprises the ML models to predict the classical resources needed to solve the problem, and when the classical resources so predicted exceed defined classical resource limits, ending the loop; constructing a quantum circuit that comprises, as among a respective set of gates and qubits of quantum algorithms in a group of quantum algorithms, a smallest set of gates and qubits; and determining minimum requirements of quantum hardware needed to run the quantum circuit with a specified fidelity.
Embodiment 2. The method as recited in any preceding embodiment, wherein each of the problem instances is relatively smaller than the problem.
Embodiment 3. The method as recited in any preceding embodiment, wherein the problem is selected based on an expectation that the problem will be more easily solved by a quantum computer than by a classical computer.
Embodiment 4 The method as recited in any preceding embodiment, wherein when the classical resources predicted by the ensemble ML model exceed the defined classical resource limits, the problem cannot be solved by a classical computing system that does not include classical resources that exceed the defined classical resource limits.
Embodiment 5. The method as recited in any preceding embodiment, wherein a QRE (quantum resource estimator) is used to determine the minimum requirements of the quantum hardware needed to run the quantum circuit with the specified fidelity.
Embodiment 6. The method as recited in embodiment 5, wherein determining the minimum requirements of the quantum hardware by the QRE comprises using an ML model to find a value of a hardware parameter that matches the specified fidelity, wherein the ML model was trained using the QRE to predict a fidelity of a given quantum circuit executed on a defined quantum hardware.
Embodiment 7. The method as recited in embodiment 6, wherein the hardware parameter comprises a two-qubit gate error.
Embodiment 8. The method as recited in any preceding embodiment, wherein after the determining of the minimum requirements of the quantum hardware needed to run the quantum circuit with the specified fidelity, the minimum requirements are used to identify quantum hardware available to run the quantum circuit.
Embodiment 9. The method as recited in any preceding embodiment, wherein the quantum circuit is run on quantum hardware that meets the minimum requirements.
Embodiment 10. The method as recited in any preceding embodiment, wherein the quantum hardware comprises a quantum advantage.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

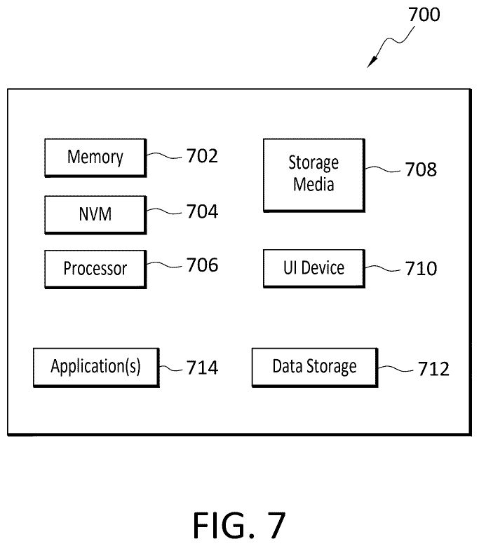

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
selecting a problem of a type;
selecting a set of classical computing algorithms;
solving, using the classical computing algorithms, respective problem instances of the problem to obtain a set of executions of the problem instances,
wherein respective ML (machine learning) models were trained using the executions of the problem instances to predict a respective amount of classical computing resources needed to execute a respective one of the problem instances by each of the classical computing algorithms;
in a loop, using an ensemble ML model that comprises the ML models to predict the classical resources needed to solve the problem, and when the classical resources so predicted exceed defined classical resource limits, ending the loop;
constructing a quantum circuit that comprises, as among a respective set of gates and qubits of quantum algorithms in a group of quantum algorithms, a smallest set of gates and qubits; and
determining minimum requirements of quantum hardware needed to run the quantum circuit with a specified fidelity.

2. The method as recited in claim 1, wherein each of the problem instances is relatively smaller than the problem.

3. The method as recited in claim 1, wherein the problem is selected based on an expectation that the problem will be more easily solved by a quantum computer than by a classical computer.

4. The method as recited in claim 1, wherein when the classical resources predicted by the ensemble ML model exceed the defined classical resource limits, the problem cannot be solved by a classical computing system that does not include classical resources that exceed the defined classical resource limits.

5. The method as recited in claim 1, wherein a QRE (quantum resource estimator) is used to determine the minimum requirements of the quantum hardware needed to run the quantum circuit with the specified fidelity.

6. The method as recited in claim 5, wherein determining the minimum requirements of the quantum hardware by the QRE comprises using an ML model to find a value of a hardware parameter that matches the specified fidelity, wherein the ML model is trained using the QRE to predict a fidelity of a given quantum circuit executed on a defined quantum hardware.

7. The method as recited in claim 6, wherein the hardware parameter comprises a two-qubit gate error.

8. The method as recited in claim 1, wherein after the determining of the minimum requirements of the quantum hardware needed to run the quantum circuit with the specified fidelity, the minimum requirements are used to identify quantum hardware available to run the quantum circuit.

9. The method as recited in claim 1, wherein the quantum circuit is run on quantum hardware that meets the minimum requirements.

10. The method as recited in claim 1, wherein the quantum hardware comprises a quantum advantage.

11. A non-transitory storage medium having stored therein instructions that are executable by one or more hardware processors to perform operations comprising:
selecting a problem of a type;
selecting a set of classical computing algorithms;
solving, using the classical computing algorithms, respective problem instances of the problem to obtain a set of executions of the problem instances;
wherein respective ML (machine learning) models were trained using the executions of the problem instances to predict a respective amount of classical computing resources needed to execute a respective one of the problem instances by each of the classical computing algorithms;
in a loop, using an ensemble ML model that comprises the ML models to predict the classical resources needed to solve the problem, and when the classical resources so predicted exceed defined classical resource limits, ending the loop;
constructing a quantum circuit that comprises, as among a respective set of gates and qubits of quantum algorithms in a group of quantum algorithms, a smallest set of gates and qubits; and
determining minimum requirements of quantum hardware needed to run the quantum circuit with a specified fidelity.

12. The non-transitory storage medium as recited in claim 11, wherein each of the problem instances is relatively smaller than the problem.

13. The non-transitory storage medium as recited in claim 11, wherein the problem is selected based on an expectation that the problem will be more easily solved by a quantum computer than by a classical computer.

14. The non-transitory storage medium as recited in claim 11, wherein when the classical resources predicted by the ensemble ML model exceed the defined classical resource limits, the problem cannot be solved by a classical computing system that does not include classical resources that exceed the defined classical resource limits.

15. The non-transitory storage medium as recited in claim 11, wherein a QRE (quantum resource estimator) is used to determine the minimum requirements of the quantum hardware needed to run the quantum circuit with the specified fidelity.

16. The non-transitory storage medium as recited in claim 15, wherein determining the minimum requirements of the quantum hardware by the QRE comprises using an ML model to find a value of a hardware parameter that matches the specified fidelity, wherein the ML model was trained using the QRE to predict a fidelity of a given quantum circuit executed on a defined quantum hardware.

17. The non-transitory storage medium as recited in claim 16, wherein the hardware parameter comprises a two-qubit gate error.

18. The non-transitory storage medium as recited in claim 11, wherein after the determining of the minimum requirements of the quantum hardware needed to run the quantum circuit with the specified fidelity, the minimum requirements are used to identify quantum hardware available to run the quantum circuit.

19. The non-transitory storage medium as recited in claim 11, wherein the quantum circuit is run on quantum hardware that meets the minimum requirements.

20. The non-transitory storage medium as recited in claim 11, wherein the quantum hardware comprises a quantum advantage.
